(19) United States
(12) Patent Application Publication
(10) Pub. No.: US 2026/0343204 A1
(43) Pub. Date: Oct. 29, 2026

(54) EMERGENCY SESSION INVITE ROUTING VIA NON-TERRESTRIAL COMMUNICATION NETWORKS

(71) Applicant: T-MOBILE INNOVATIONS LLC, Overland Park, KS (US)

(72) Inventors: Saqib Badar, Bellevue, WA (US); Mehul Jayant Shah, Sammamish, WA (US)

(21) Appl. No.: 19/192,777

(22) Filed: Apr. 29, 2025

(51) Int. Cl. H04W 8/08; H04W 4/90

(52) U.S. Cl. CPC H04W 8/08; H04W 4/90

(57) ABSTRACT

Various embodiments include a system that comprises a network controller, a network data system, and an Internet Protocol Multimedia Subsystem (IMS) of a home wireless communication network. The network controller receives a registration request for a user device roaming on a visited non-terrestrial communication network. The network controller registers the user device and stores an indication in the network data system that the user device is roaming and that identifies the visited network controller. The IMS receives an emergency multimedia session invite for the user device. The IMS accesses the network data system to determine that the user device is roaming on the visited non-terrestrial communication network and to identify the visited network controller. The IMS transfers the emergency multimedia session invite for delivery to the visited network controller. The visited network controller delivers the emergency multimedia session invite to the user device.

### TECHNICAL FIELD

Various embodiments of the present technology relate to wireless communications, and more specifically, to routing emergency multimedia session invites to user devices via non-terrestrial networks in response to emergency call failure.

### BACKGROUND

Wireless terrestrial communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Non-terrestrial communication networks are wireless communication networks that utilize non-terrestrial access nodes. A non-terrestrial access node comprises a satellite and a ground station that communicatively couple user devices with the core network. The satellite typically resides in low-earth orbit and wirelessly exchanges signaling and data with the user devices and the ground station. The ground station receives the wireless signals and routes the signaling and data to the core network over wired backhaul links. Non-terrestrial communication networks may partner with terrestrial communication networks to cover coverage gaps of the terrestrial communication networks.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for wireless communications. Some embodiments comprise a method. The method comprises receiving, by a network controller of a home wireless communication network, a registration request for a user device roaming on a visited non-terrestrial communication network from a visited network controller over a roaming interface between the home wireless communication network and the visited non-terrestrial communication network. The method further comprises registering, by the network controller, the user device for roaming service on the visited non-terrestrial communication network. The method further comprises storing, by the network controller, an indication in a network data system that indicates that the user device is roaming on the visited non-terrestrial communication network and that identifies the visited network controller. The method further comprises receiving, by an Internet Protocol Multimedia Subsystem (IMS) of the home wireless communication network, an emergency multimedia session invite for the user device. The user device previously initiated an emergency multimedia session that subsequently failed over the visited non-terrestrial communication network and a visited IMS without registering with the IMS. The method further comprises accessing, by the IMS, the network data system to determine that the user device is roaming on the visited non-terrestrial communication network and to identify the visited network controller. The method further comprises transferring, by the IMS, the emergency multimedia session invite for delivery to the visited network controller. The visited network controller delivers the emergency multimedia session invite to the user device over a user plane data link to the user device that traverses a non-terrestrial access node.

Some embodiments comprise a system. The system comprises a network controller, a network data system, and an IMS of a home wireless communication network. The network controller receives a registration request for a user device roaming on a visited non-terrestrial communication network from a visited network controller over a roaming interface between the home wireless communication network and the visited non-terrestrial communication network. The network controller registers the user device for roaming service on the visited non-terrestrial communication network. The network controller stores an indication in the network data system that indicates that the user device is roaming on the visited non-terrestrial communication network and identifies the visited network controller. The IMS receives an emergency multimedia session invite for the user device. The user device previously initiated an emergency multimedia session that subsequently failed over the visited non-terrestrial communication network and a visited IMS without registering with the IMS. The IMS accesses the network data system to determine that the user device is roaming on the visited non-terrestrial communication network and to identify the visited network controller. The IMS transfers the emergency multimedia session invite for delivery to the visited network controller. The visited network controller delivers the emergency multimedia session invite to the user device over a user plane data link to the user device that traverses a non-terrestrial access node.

Some embodiments comprise one or more non-transitory computer readable storage media having program instructions stored thereon. When executed by a computing system, the program instructions direct the computing system to perform operations. The operations comprise receiving a registration request for a user device roaming on a visited non-terrestrial communication network from a visited network controller. The operations further comprise registering the user device for roaming service on the visited non-terrestrial communication network. The operations further comprise storing an indication in a network data system of the home wireless communication network that indicates that the user device is roaming on the visited non-terrestrial communication network and identifies the visited network controller. The operations further comprise receiving an emergency multimedia session invite for the user device. The user device previously initiated an emergency multimedia session that subsequently failed over the visited non-terrestrial communication network without registering with an IMS of the home wireless communication network. The operations further comprise accessing the network data system to determine that the user device is roaming on the visited non-terrestrial communication network and to identify the visited network controller. The operations further comprise transferring the emergency multimedia session invite for delivery to the visited network controller. The visited network controller delivers the emergency multimedia session invite to the user device.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a communication network to route an emergency session invite to a user device via a non-terrestrial network in response to call failure.

FIG. 2 illustrates an exemplary operation of the communication network to route an emergency session invite to a user device via a non-terrestrial network in response to call failure.

FIG. 3 illustrates another exemplary operation of the communication network to route an emergency session invite to a user device via a non-terrestrial network in response to call failure.

FIG. 4 illustrates an example of a Fifth Generation (5G) communication network to route an emergency session invite to a User Equipment (UE) via a non-terrestrial network in response to call failure.

FIG. 5 illustrates an example of a User Equipment (UE) in the 5G communication network that routes an emergency session invite to a UE via a non-terrestrial network in response to call failure.

FIG. 6 illustrates an example of a Non-Terrestrial Access Node (NT AN) in a non-terrestrial communication network.

FIG. 7 further illustrates the example of the NT AN in the non-terrestrial communication network.

FIG. 8 illustrates an example of a 5G data center and Internet Protocol Multimedia Subsystem (IMS) data center in the 5G communication network that routes an emergency session invite to a UE via a non-terrestrial network in response to call failure.

FIG. 9 further illustrates the 5G data center and IMS data center in the 5G communication network that routes an emergency session invite to a UE via a non-terrestrial network in response to call failure.

FIG. 10 illustrates an exemplary operation of the 5G communication network to route an emergency session invite to a UE via a non-terrestrial network in response to call failure.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

Non-terrestrial communication networks utilize non-terrestrial (e.g., space based) access nodes to communicate with user devices. Non-terrestrial communication networks often have limited functionality when compared to traditional terrestrial communication networks. Non-terrestrial communication networks often partner with terrestrial communication networks to fill in coverage gaps and may rely on the terrestrial communication networks for services like inter-network connectivity. As such, when user devices exit the coverage area of their home terrestrial communication network, the user devices may roam on a partnered non-terrestrial communication network. While roaming on a non-terrestrial network, a user device may place an emergency call. To expedite call setup, the user device forgoes Internet Protocol Multimedia Subsystem (IMS) registration with its home network and completes the call using the IMS of the non-terrestrial communication network. In the event the call fails, the emergency services may transfer a call invite to reestablish the call. The call invite is routed to the home network IMS based on the user device's phone number's association with the home terrestrial communication network. However, since the user device did not register with the home network IMS, the home network IMS forwards the invite to a voicemail server inhibiting call setup. This degrades the overall user experience, especially during emergency situations.

To overcome the above-described problems in conventional wireless communication networks, various embodiments of the present technology relate to routing emergency multimedia session invites to user devices via non-terrestrial communication networks in response to call failure. In some examples, a home network controller receives a registration request for a user device roaming on a non-terrestrial network from a visited network controller. The home network controller stores an indication in a network data system that indicates the user device is roaming on the non-terrestrial communication network and that identifies the visited network controller. When the user device engages in an emergency multimedia session that subsequently fails, the home network IMS receives a multimedia call invite from emergency services to reestablish emergency multimedia session. The IMS accesses the network data system to determine that the user device is roaming on the non-terrestrial communication network and to identify the visited network controller. In response, the IMS routes the multimedia call invite to the visited network controller. The visited network controller may then deliver the call invite to the roaming user device over a data link that traverses a non-terrestrial access node. The emergency multimedia session may then be reestablished over the non-terrestrial communication network. Tracking roaming status of user devices and routing call invites to visited non-terrestrial controllers facilitates the reestablishment of emergency voice sessions. This improves the overall user experience, especially during emergency situations. Now referring to the Figures.

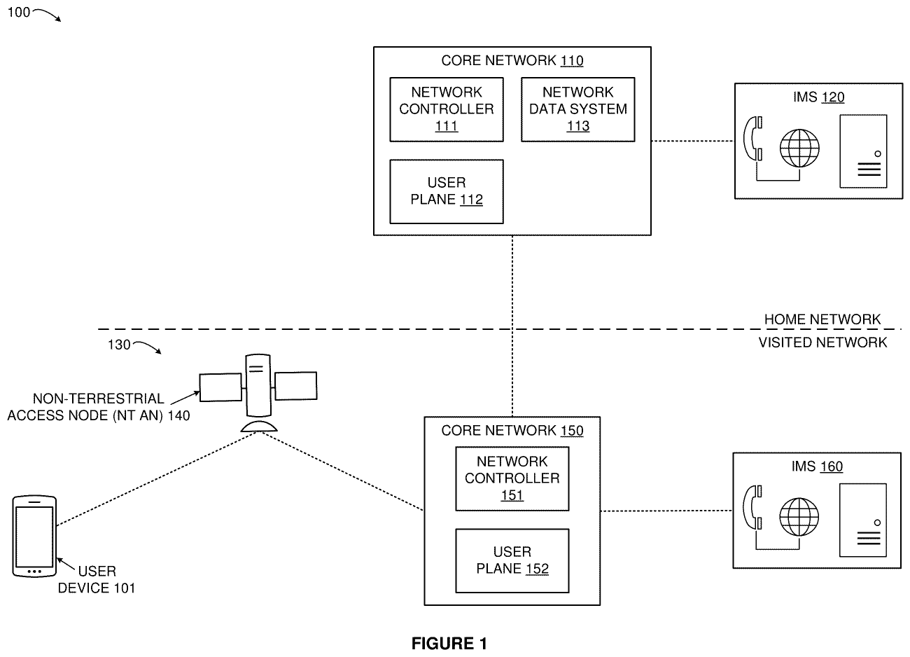

FIG. 1 illustrates communication network 100 and non-terrestrial communication network 130 to route emergency multimedia session invite to user devices via non-terrestrial communication network 130 in response to call failure. Communication network 100 provides services like media-streaming, media-broadcasting, internet-access, voice/video calling, text messaging, online gaming, social media, machine communications, remote device control, or some other wireless communications product. Communication network 100 comprises user device 101, core network 110, and IMS 120. Core network 110 comprises network controller 111, user plane 112, and network data system 113. Non-terrestrial communication network 130 comprises Non-Terrestrial Access Node (NT AN) 140, core network 150, and IMS 160. Core network 150 comprises network controller 151 and user plane 152. In other examples, communication network 100 and non-terrestrial communication network 130 may comprise additional or different elements than those illustrated in FIG. 1.

Various examples of network operation and configuration are described herein. In some examples, user device 101 moves outside of the coverage range of communication network 100 due to user mobility and elects to roam on non-terrestrial communication network 130. Communication network 100 is representative of the home network of user device 101 while non-terrestrial communication network 130 is representative of the visited network of user device 101. Communication network 100 typically comprises a terrestrial communication network, however communication network 100 may comprise a non-terrestrial communication network. User device 101 wirelessly attaches to NT AN 140 and transfers a registration request to network controller 151 via NT AN 140. The registration request indicates that user device 101 is roaming on non-terrestrial communication network 130. For example, the registration request may include a Public Land Mobile Network (PLMN) Identifier (ID) for communication network 100. Network controller 151 determines user device 101 is visiting from communication network 100 and forwards the registration request to network controller 111 via a roaming interface between communication network 100 and non-terrestrial communication network 130. Network controller 111 authenticates user device 101 and authorizes user device 101 for roaming service on non-terrestrial communication network 100. Responsive to authentication and authorization, network controller 111 registers user device 101 and transfers a registration accept message to network controller 151. Network controller 151 transfers the registration accept message to user device 101 of NT AN 140. Network controller 111 stores an indication in network data system 113 that indicates user device is roaming on non-terrestrial communication network 130 and that identifies network controller 151.

The user of user device 101 experiences an emergency and places an emergency call on user device 101. Since user device 101 places an emergency call, user device 101 forgoes registering with IMS 120 in its home network (i.e., communication network 100) to expedite delivery of the call. User device 101 transfers an emergency call invite to IMS 160 over NT AN 140 and core network 150. IMS 160 establishes the voice call between emergency services (not illustrated) and user device 101 over NT AN 140 and core network 150.

Subsequently, the call between user device 101 and emergency services fails. The emergency services attempt to reestablish the voice call and transfer a multimedia call invite for delivery to user device 101. Since user device 101's phone number is associated with communication network 100, IMS 120 receives the call invite from the emergency services. However, since user device 101 did not register with IMS 120, IMS 120 accesses network data system 113 to determine the network location of user device 101. IMS 120 determines user device 101 is roaming on non-terrestrial network 130 and identifies network controller 151. In response, IMS 120 transfers the multimedia call invite to network controller 151. Network controller 151 delivers the invite to user device 101 via a user plane data link that traverses NT AN 140. User device 101 accepts the invite and reestablishes the emergency call with the emergency services. The reestablished call may comprise a home routed call (e.g., established via IMS 120) or may be reestablished via IMS 160. Advantageously, communication network 100 effectively and efficiently tracks non-terrestrial network roaming status for user devices and routes call invites to reestablish emergency multimedia sessions to user devices via visited network controllers.

User device 101 may comprise a phone, computer, vehicle, drone, robot, sensor, or another type of data appliance with wireless and/or wireline communication circuitry. User device 101 and NT AN 140 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), Low-Power Wide Area Network (LP-WAN), and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

NT AN 140 may comprise a Sixth Generation (6G) Radio Access Network (RAN) node, Fifth Generation (5G) RAN node, LTE RAN node, gNodeB, eNodeB, Narrow Band Internet-of-Things (NB-IoT) access node, WiFi access node, trusted non-Third Generation Partnership Project (3GPP) access node, untrusted non-3GPP access node, Low Power-Wide Area Network (LP-WAN) base station, wireless relay, and/or another type of non-terrestrial wireless network transceiver. While NT AN 140 is illustrated as a satellite-based access node, NT AN 140 may comprise terrestrial elements like ground stations to couple NT AN 140 and core network 150. NT AN 140 exchanges network signaling and user data with network functions clustered together into core network 150. NT AN 140 is connected to core network 150 over one or more backhaul data links. A ground station of NT AN 140 and core network 150 may communicate via edge networks like internet backbone providers, edge computing systems, or another type of edge system to provide the backhaul data and signaling links between NT AN 140 and core network 150.

Core network 110, IMS 120, core network 150, and IMS 160 are representative of computing systems that provide wireless data services to user device 101. Exemplary computing systems comprise Network Function Virtualization Infrastructure (NFVI) systems, data centers, server farms, cloud computing networks, hybrid cloud networks, and the like. Core network 110 and core network 150 may comprise a 3GPP core network architecture like Sixth Generation Core (6GC), Fifth Generation Core (5GC), Evolved Packet Core (EPC), and/or another type of 3GPP core network architecture. Core network 110, IMS 120, core network 150, and IMS 160 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols.

The computing systems of core networks 110 and 150 store and execute the network functions/entities to form network controllers 111 and 151, user planes 112 and 152, and network data system 113. Network controllers 111 and 151 may comprise network functions like Access and Mobility Management Function (AMF), Session Management Function (SMF), Policy Control Function (PCF), Mobility Management Entity (MME), Policy and Rules Charging Function (PCRF), and the like. User planes 112 and 152 may comprise network functions like User Plane Function (UPF), Packet Gateway (P-GW), Serving Gateway (S-GW), and the like. Network data system 113 comprises network functions like Unified Data Management (UDM), Home Subscriber Server (HSS), Home Subscriber Register (HLR), and the like. The computing systems of IMS 120 and 160 store and execute multimedia functions to provide services like voice calling, video conferencing, and text messaging to user device 101. Exemplary multimedia functions include Call Session Control Function (CSCF), Telephony Application Server (TAS), Breakout Gateway Control Function (BGCF), and the like.

User device 101 and NT AN 140 comprise antennas, amplifiers, filters, modulation, analog/digital interfaces, microprocessors, software, memories, transceivers, bus circuitry, and the like. User device 101, core network 110 and 150, IMS 120 and 160, and NT AN 140 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

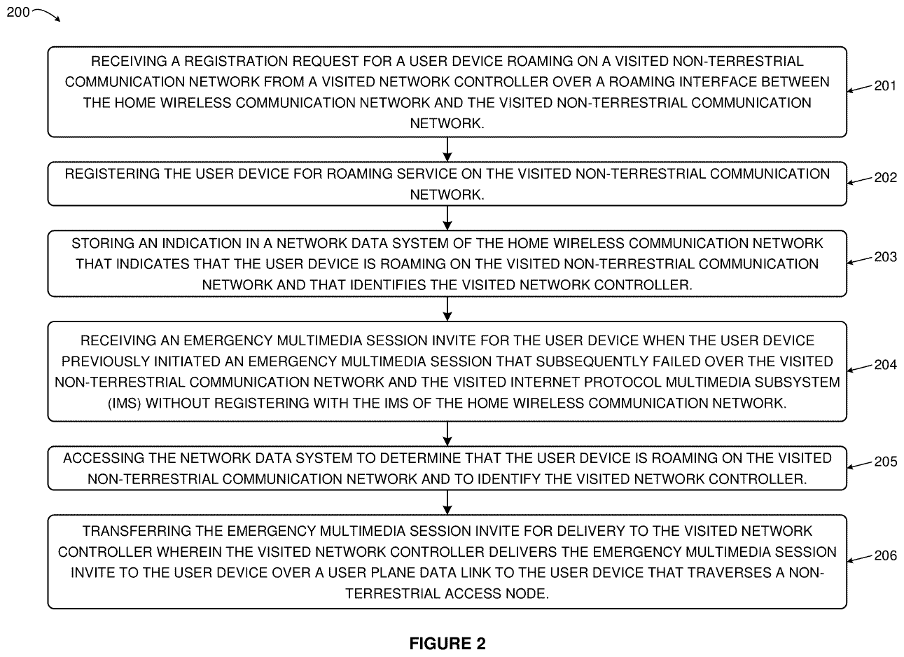

FIG. 2 illustrates process 200. Process 200 comprises an exemplary operation of communication network 100 to route emergency multimedia session invite to user devices via non-terrestrial communication network 130 in response to call failure. The operations of process 200 comprise receiving a registration request for a user device roaming on a visited non-terrestrial communication network from a visited network controller over a roaming interface between the home wireless communication network and the visited non-terrestrial communication network (step 201). For example, the home wireless communication network may comprise a terrestrial communication network or non-terrestrial communication network. The registration request may be received at a network controller (e.g., AMF, MME, etc.) of the home wireless communication network. The operations further comprise registering the user device for roaming service on the visited non-terrestrial communication network (step 202). The operations further comprise storing an indication in a network data system of the home wireless communication network that indicates that the user device is roaming on the visited non-terrestrial communication network and that identifies visited network controller (step 203). The operations further comprise receiving an emergency multimedia session invite for the user device when the user device previously initiated an emergency multimedia session that subsequently failed over the visited non-terrestrial communication network and the visited IMS without registering with the IMS of the home wireless communication network (step 204). The operations further comprise accessing the network data system to determine that the user device is roaming on the visited non-terrestrial communication network and to identify the visited network controller (step 205). The operations further comprise transferring the emergency multimedia session invite for delivery to the visited network controller wherein the visited network controller delivers the emergency multimedia session invite to the user device over a user plane data link to the user device that traverses a non-terrestrial access node (step 206).

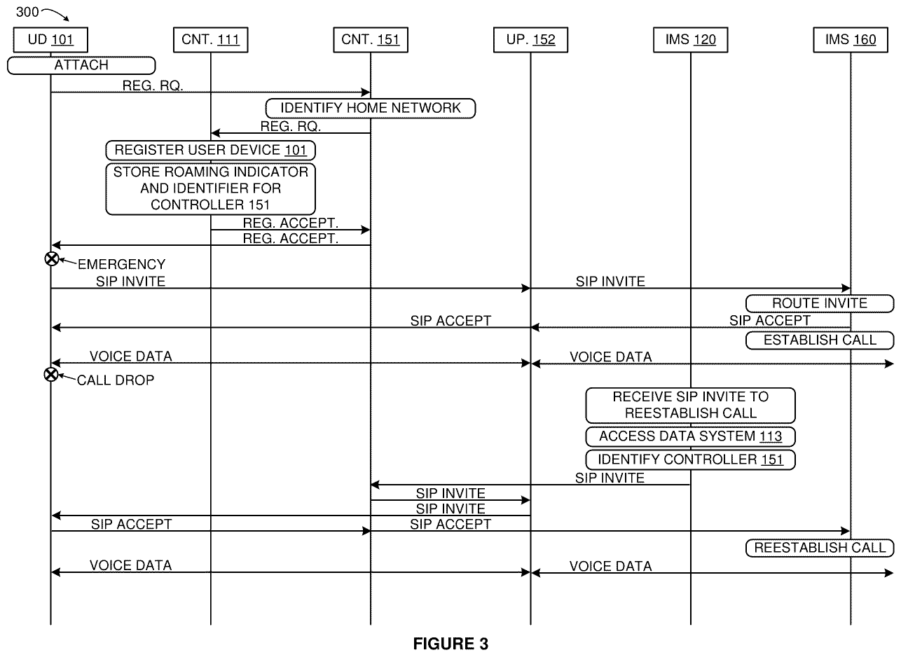

FIG. 3 illustrates process 300. Process 300 comprises an exemplary operation of communication network 100 to route emergency multimedia session invite to user devices via non-terrestrial communication network 130 in response to call failure. Process 300 comprises an example of process 200 illustrated in FIG. 2, however process 200 may differ. Process 300 may vary in other examples. In some examples, NT AN 140 broadcasts reference signals. The reference signals include information which is used by user devices to initiate communications with NT AN 140. User device (UD) 101 receives the reference signals and measures SINR, RSRP, and/or other radio metrics (e.g., Received Signal Received Quality (RSRQ)) of the reference signals. When the signal strength of the reference signals exceeds quality and/or strength thresholds, user device 101 attaches to NT AN 140.

User device 101 attaches to NT AN 140 based on the reference signals. NT AN 140 transfers a random access response to user device 101. The response comprises information like a timing advance command, uplink grant, and temporary identifier. User device 101 generates and transfers a connection setup request using the uplink grants at the times specified by the timing advance command to NT AN 140. For example, the connection setup request may comprise a Radio Resource Control (RRC) setup request. NT AN 140 allocates radio resources to user device 101 to establish a wireless connection with user device 101.

In response to the connection setup, user device 101 generates a registration request to receive service on non-terrestrial communication network 130. User device 101 transfers the registration request to network controller (CNT.) 151 via NT AN 140. The registration request identifies communication network 100 as the home network of user device 101 and includes information like subscriber Identifier (ID), Protocol Data Unit (PDU) session request requests, and the like. Network controller 151 determines the user device 101 is roaming on non-terrestrial communication network 130 and identifies communication network 100 as the home network based on the indication included in the registration request. In response, network controller 151 forwards the registration request to network controller (CNT.) 111 over the roaming interface between communication network 100 and non-terrestrial communication network 130. Network controller 111 interfaces with network data system 113 to authenticate user device 101 and authorize user device 101 for service on non-terrestrial communication network 130.

Responsive to authentication and authorization, network controller 111 registers user device 101. Network controller 111 stores data in network data system 113 indicating user device 101's roaming status and an ID for network controller 151. Network controller 111 transfers the registration accept message to user device 101 via network controller 151 and NT AN 140. The registration accept message includes information like device context, network addresses, and/or other information for user device 101 to begin its data session. User device 101 executes its network applications and user applications to begin its PDU session on non-terrestrial communication network 130. The user applications generate user data for the PDU session. User device 101 exchanges the user data with user plane 152 over NT AN 140.

Subsequently, the user of user device 101 experiences an emergency and places an emergency call using user device 101. To expedite emergency call setup, user device 101 transfers an emergency call Session Initiation Protocol (SIP) invite to IMS 160 over NT AN 140 and user plane 152 without registering with IMS 120 in communication network 100. IMS 160 routes the SIP invite to emergency services which accepts the call and transfers a SIP accept message to IMS 160. IMS 160 routes the SIP accept message to user device 101 over user plane 152 and NT AN 140. IMS 160 organizes the end-to-end connection between user device 101 and emergency services. User device 101 begins the voice call and exchanges voice data with emergency services over the end-to-end connection that traverses NT AN 140 and user plane 152.

During the emergency voice call, an error occurs causing the call to drop. For example, atmospheric conditions may interfere with the wireless connection between user device 101 and NT AN 140 causing the call to drop. In response, the emergency services attempt to reestablish the call with user device 101. The emergency services transfer a SIP invite to IMS 120 since user device 101's phone number is associated with communication network 100. IMS 120 determines that user device 101 is not registered with IMS 120. Before deciding to connect emergency services with user device 101's voicemail server, IMS 120 attempts to locate user device 101 by accessing network data system 113. Network data system 113 indicates that user device 101 is roaming on non-terrestrial communication network 130 and provides the ID of network controller 151 to IMS 120. In response, IMS 120 routes the SIP invite to network controller 151 via network controller 111. Network controller 151 delivers the SIP invite to user device 101 over user plane 152 and NT AN 140. User device 101 accepts the call and transfers a SIP accept message to user plane 152 over NT AN 140. User plane 152 delivers the SIP accept message to the emergency services over IMS 160 (or alternatively IMS 120 via the roaming interface between networks 100 and 130). IMS 160 organizes the end-to-end connection between user device 101 and the emergency services. User device 101 begins the voice call and exchanges voice data with emergency services over the end-to-end connection that traverses NT AN 140 and user plane 152.

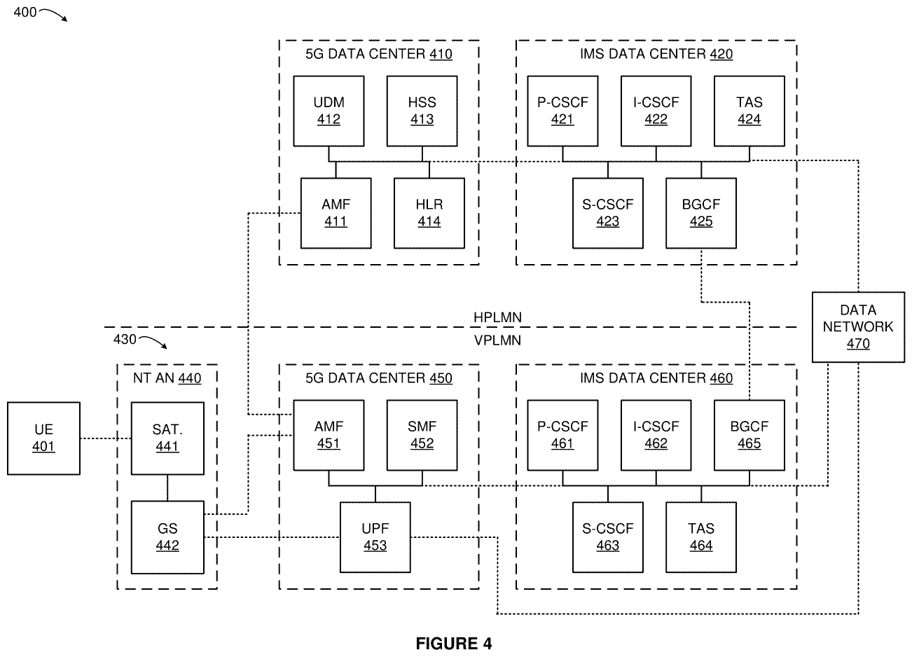

FIG. 4 illustrates 5G communication network 400 to route an emergency session invite to a User Equipment (UE) via non-terrestrial communication network 430 in response to call failure. 5G communication network 400 comprises an example of communication network 100 illustrated in FIG. 1, however communication network 100 may differ. Non-terrestrial communication network 430 comprises an example of non-terrestrial communication network 130 illustrated in FIG. 1, however non-terrestrial communication network 130 may differ. 5G communication network 400 is representative of the Home PLMN (HPLMN)of UE 401 while non-terrestrial communication network 430 is representative of the Visited PLMN (VPLMN) of UE 401. FIG. 4 also illustrates data network 470. 5G communication network 400 comprises UE 401, 5G data center 410, and IMS data center 420. 5G data center 410 comprises AMF 411, UDM 412, HSS 413, and HLR 414. IMS data center 420 comprises Proxy-CSCF (P-CSCF) 421, Interrogating-CSCF (I-CSCF) 422, Serving-CSCF (S-CSCF) 423, TAS 424, and BGCF 425. Non-terrestrial communication network 430 comprises NT AN 440, 5G data center 450, IMS data center 460. NT AN 440 comprises satellite (SAT.) 441 and ground station (GS) 442. 5G data center 450 comprises AMF 451, SMF 452, and UPF 453. IMS data center 460 comprises P-CSCF 461, I-CSCF 462, S-CSCF 463, TAS 464, and BGCF 465. Other network functions and network entities like Policy Control Function (PCF), Authentication Server Function (AUSF), Network Slice Selection Function (NSSF), Charging Function (CHF), Network Repository Function (NRF), Unified Data Registry (UDR), Short Message Service Function (SMSF), Network Exposure Function (NEF), Application Function (AF), Equipment Identity Register (EIR), and Session Communication Proxy (SCP) are typically present in 5G data center 410 and 5G data center 450 but are omitted for clarity. In other examples, 5G communication network 400 may comprise different or additional elements than those illustrated in FIG. 4.

In some examples, UE 401 moves out of the service area of 5G communication network 400 due to user mobility. UE 401 decides to roam on non-terrestrial network 430 to maintain network connectivity. NT AN 440 broadcasts synchronization signals to indicate its availability to terrestrial user devices. UE 401 receives and measures signal metrics like Received Signal Received Power (RSRP) and Received Signal Received Quality (RSRQ) of the synchronization signals and decides to attach to NT AN 440. In response, UE 401 wirelessly attaches to NT AN 440 over a 5GNR link and transfers random preamble to NT AN 440 to initiate a Random Access Channel (RACH) procedure to establish a secure signaling channel. NT AN 440 receives the preamble and assigns a Cell-Radio Network Temporary Identifier (C-RNTI) to UE 401. NT AN 440 wirelessly transfers a random access response to UE 401. The random access response includes a timing advance command, uplink grant, and the C-RNTI. UE 401 extracts the uplink grant and timing advance command from the response and transfers an RRC setup request to NT AN 440 based on the uplink grant and timing advance command. The RRC setup request comprises a UE identity indication and the establishment cause. NT AN 440 establishes a radio signaling bearer for UE 401 and transfers an RRC setup message to UE 401. The RRC setup message comprises a radio bearer configuration and cell ID. UE 401 establishes an RRC connection with NT AN 440 based on the radio bearer configuration and cell ID.

UE 401 generates and transfers a registration request to AMF 451 over NT AN 440. The registration request indicates a registration type, 5G-Global Unique Temporary Identifier (GUTI), Tracking Area Identifier (TAI), Network Slice Selection Assistance Information (NSSAI) requests, UE capability report, PDU session requests, and the like. The registration request includes the PLMN ID of 5G communication network to identify 5G communication network 100 as UE 401's HPLMN. Since UE 401 is roaming, AMF 451 forwards the registration request to AMF 411 over the network roaming interface. In response to the registration request, AMF 411 transfers a Non-Access Stratum (NAS) identity request to UE 401 over AMF 451 and NT AN 440. UE 401 returns the Subscriber Concealed Identifier (SUCI) of UE 401 to AMF 411 over NT AN 440 and AMF 451. AMF 411 interfaces UDM 412 and typically other network functions to authenticate the identity of UE 401. Typically, authentication involves presenting a random number challenge to UE 401 and matching an authentication response from UE 401 with an expected result to verify the identity of UE 401.

Responsive to the authentication, AMF 411 interfaces with other network functions (e.g., UDM 412) to generate context for UE 401. The UE context defines the authorized services for UE 401, including authorization for roaming service on non-terrestrial communication network 430. To form the context, AMF 411 retrieves access and mobility subscription data, SMF selection subscription data, and UE context in SMF data from UDM 412. The access and mobility subscription data comprises a supported feature list for UE 401 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. AMF 411 forms the UE context for UE 401 using the retrieved information.

Responsive to authentication and authorization, AMF 411 registers UE 401 for roaming service on non-terrestrial communication network 430. AMF 411 accesses a subscriber profile for UE 401 stored by HSS 413 and modifies the profile to indicate UE 401 is roaming on non-terrestrial communication network 430 and to identify AMF 451 by AMF ID. AMF 411 generates a registration accept message that includes the UE context and transfers the registration accept message to AMF 451. AMF 451 selects SMF 452 to serve UE 401 based on SMF selection data. AMF 521 transfers a list of requested PDU sessions (as received during the registration request), a PDU session activation command, and the SUPI to SMF 452. SMF 452 allocates IP addresses to UE 401 for the requested PDU sessions and allocates a Tunnel Endpoint Identifier (TEID) for the session. SMF 522 selects UPF 453 to serve UE 401. SMF 452 transfers a session modification request that includes a session endpoint identifier and TEID to UPF 453 to set up the PDU sessions for UE 401. UPF 453 sets up a default bearer for UE 401 with NT AN 440. UPF 453 returns a session modification response to SMF 452 to confirm bearer setup.

SMF 522 returns a PDU session create response to AMF 521 to confirm session creation. The response includes the updated session context (e.g., allocated IP addresses, TEID, etc.). AMF 451 modifies the registration accept message to include the allocated UE IP address, RAN ID, AMBR, Globally Unique AMF ID (GUAMI), PDU session ID, PDU session TEID, allowed NSSAI list, security data, and the like. AMF 521 transfers the registration accept message to UE 401 over NT AN 440 and directs NT AN 440 to serve UE 401. UE 401 begins its PDU sessions on non-terrestrial communication network 430 based on the UE context received in the registration accept message. UE 401 exchanges user data with data network 470 over NT AN 440 and UPF 453.

While UE 401 is roaming on non-terrestrial communication network 430, the user of UE 401 experiences an emergency and places a voice call towards emergency services (e.g., dials 911) using UE 401. Since the call is an emergency call, UE 401 forgoes registering with IMS data center 420 in 5G communication network 400 to expedite call setup. UE 401 generates and transfers a SIP invite to P-CSCF 461 over NT AN 440 and UPF 453. P-CSCF 461 interfaces with I-CSCF 462 to select S-CSCF 463. S-CSCF 463 delivers the SIP invite to emergency services via data network 470 and responsively receives a SIP accept message from the emergency services. S-CSCF 463 delivers the SIP accept message to UE 401 over P-CSCF 461, UPF 453, and NT AN 440. S-CSCF 463 organizes the end-to-end connection between UE 401 and the emergency services. UE 401 receives the SIP accept message and begins the voice call. S-CSCF 463 and TAS 464 monitor and support the voice call. UE 401 exchanges voice data with the emergency services of the end-to-end connect that traverses NT AN 440, UPF 453, and data network 470.

During the emergency call, a problem occurs causing the call to drop. The emergency services detect the call failure and dial the phone number of UE 401 to reestablish the call. The emergency services transfer a SIP invite towards P-CSCF 421 in IMS data center 420 since UE 401's phone number is associated with 5G communication network 400. P-CSCF 421 receives the SIP invite and determines that UE 401 is not registered with IMS data center 420. Before forwarding the SIP invite to UE 401's voicemail server, P-CSCF 421 attempts to locate UE 401. P-CSCF 421 accesses UE 401's subscriber profile stored by HSS 413 and determines that UE 401 is roaming on non-terrestrial communication network 430 and identifies AMF 451 in 5G data center 450. P-CSCF 421 also interfaces with HLR 414 to determine if an underlying packet switching network connection exists between IMS data center 420 and IMS data center 460. When a packet switching network connection does not couple IMS data centers 420 and 460, P-CSCF 421 forwards the SIP invite to AMF 451 via AMF 411 (or another suitable routing path). AMF 451 delivers the SIP invite to UE 401 over the user plane link between UPF 453 and UE 401. UE 401 accepts the call and transfers a SIP accept message towards the emergency services via UPF 453 and data network 470 to reestablish the voice call. When a packet switching network connection exists between IMS data centers 420 and 460, P-CSCF 421 routes the SIP invite to P-CSCF 461 via BGCF 425 and BGCF 465. P-CSCF 461 delivers the SIP invite to UE 401 via UPF 453 and NT AN 440. UE 401 accepts the call and transfers a SIP accept message towards the emergency services via UPF 453 and data network 470 to reestablish the voice call. P-CSCF 421 may additionally transfer the SIP invite to AMF 451 (i.e., as described when a packet switching network connection is not present) as backup. AMF 451 may then deliver the SIP invite to UE 401 via the data link.

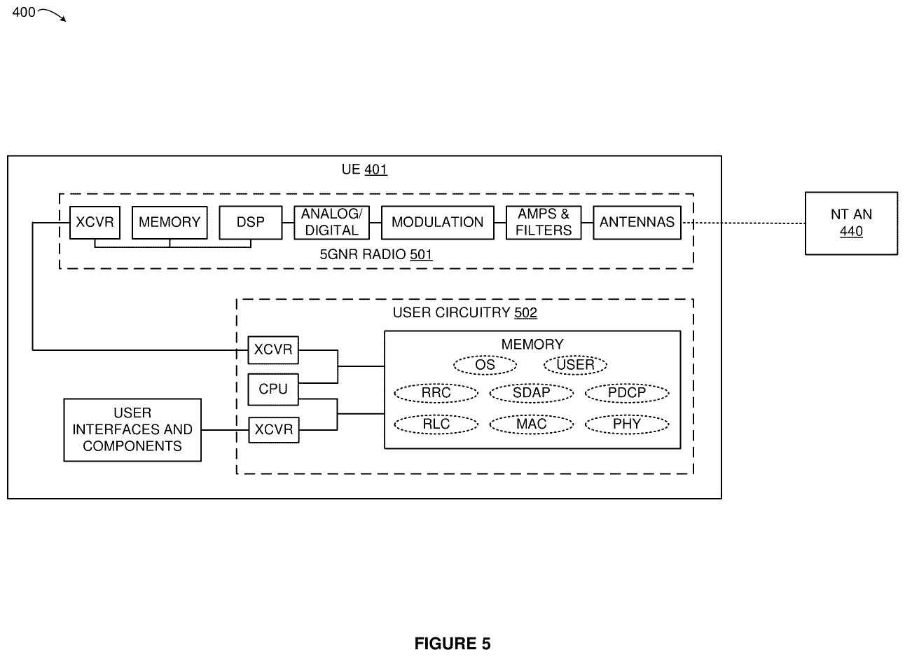

FIG. 5 illustrates UE 401 in 5G communication network 400. UE 401 comprises an example of user device 101 illustrated in FIG. 1, although user device 101 may differ. UE 401 comprises 5G radio 501 and user circuitry 502. 5G radio 501 comprises 5GNR antennas, amplifiers, filters, modulation, analog-to-digital interfaces, Digital Signal Processers (DSP), memory, and transceivers (XCVRs) that are coupled over bus circuitry. User circuitry 502 comprises memory, CPU, user interfaces and components, and transceivers that are coupled over bus circuitry.

The memory in user circuitry stores an operating system (OS), user applications (USER), and 5GNR network applications for PHY, MAC, RLC, PDCP, SDAP, and RRC. The antenna in 5G radio 501 is wirelessly coupled to NT AN 440 over a 5GNR link. Transceivers in 5G radio 501 are coupled to a transceiver in user circuitry 502. A transceiver in user circuitry 502 is typically coupled to user interfaces and components like displays, controllers, and memory.

In 5G radio 501, the antennas receive wireless signals from NT AN 440 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 502 over the transceivers. In user circuitry 502, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 501, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to NT AN 440 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

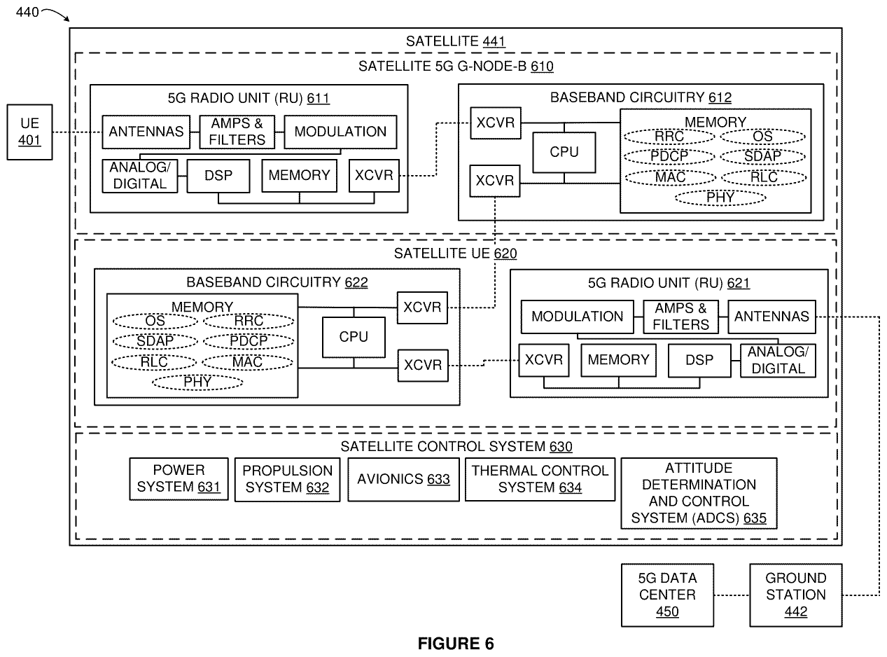

FIG. 6 illustrates satellite 441 in NT AN 440 in 5G communication network 400. NT AN 440 comprises an example of NT AN 140 illustrated in FIG. 1, although NT AN 140 may differ. Satellite 441 comprises satellite 5G gNodeB 610, satellite UE 620, and satellite control system 630. Satellite 5G gNodeB 610 comprises 5G Radio Unit (RU) 611 and baseband circuitry 612. Satellite UE 620 comprises 5G RU 621 and baseband circuitry 622. Satellite control system 630 comprises power system 631, propulsion system 632, avionics 633, thermal control system 634, and Attitude Determination and Control System (ADCS) 635. RU 611 and RU 621 comprise 5GNR antennas, amplifiers, filters, modulation, analog-to-digital interfaces, DSP, memory, and transceivers (XCVRs) that are coupled over bus circuitry. UE 401 is wirelessly coupled to antennas in RU 611 over 5GNR links. Ground station 442 is coupled to antennas in RU 621 over 5GNR links. Transceivers in RU 511 are coupled to transceivers in baseband circuitry 612. Transceivers in baseband circuitry 612 are coupled to transceivers in baseband circuitry 622. Transceivers in baseband circuitry 622 are coupled to transceivers in RU 621. The DSP in RU 611 executes its operating system and radio applications to exchange 5GNR signals with UE 401 and to exchange 5GNR data with baseband circuitry 612. The DSP in RU 621 executes its operating system and radio applications to exchange 5GNR signals with ground station 442 and to exchange 5GNR data with baseband circuitry 622. Baseband circuitry 612 comprises memory, CPU, and transceivers that are coupled over bus circuitry. The memory in baseband circuitry 612 stores operating systems and 5GNR network applications like PHY, MAC, RLC, PDCP, SDAP, and RRC. Baseband circuitry 622 comprises memory, CPU, and transceivers that are coupled over bus circuitry. The memory in baseband circuitry 622 stores operating systems and 5GNR network applications like PHY, MAC, RLC, PDCP, SDAP, and RRC.

For the uplink, the antennas in RU 611 receive wireless signals from UE 401 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to baseband circuitry 612 over the transceivers. The CPU in baseband circuitry 612 executes the operating system and 5GNR applications to generate uplink 5GNR signaling and data based on the 5GNR symbols. Baseband circuitry 612 transfers the uplink 5GNR signaling and data to baseband circuitry 622 over the transceivers. The CPU in baseband circuitry 622 executes the operating system and 5GNR applications to generate uplink 5GNR symbols based on the 5GNR signaling and data. Baseband circuitry 622 transfers the uplink 5GNR symbols to RU 621 over the transceivers. The DSPs process the uplink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to ground station 442 that transport the uplink 5GNR signaling and data.

For the downlink, the antennas in RU 621 receive wireless signals from ground station 442 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding downlink 5GNR symbols to baseband circuitry 622 over the transceivers. The CPU in baseband circuitry 622 executes the operating system and 5GNR applications to generate downlink 5GNR signaling and data based on the downlink 5GNR symbols. Baseband circuitry 622 transfers the downlink 5GNR signaling and data to baseband circuitry 612 over the transceivers. The CPU in baseband circuitry 612 executes the operating system and 5GNR applications to generate downlink 5GNR symbols based on the downlink 5GNR signaling and data. Baseband circuitry 612 transfers the downlink 5GNR symbols to RU 611 over the transceivers. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 401 that transport the downlink 5GNR signaling and data.

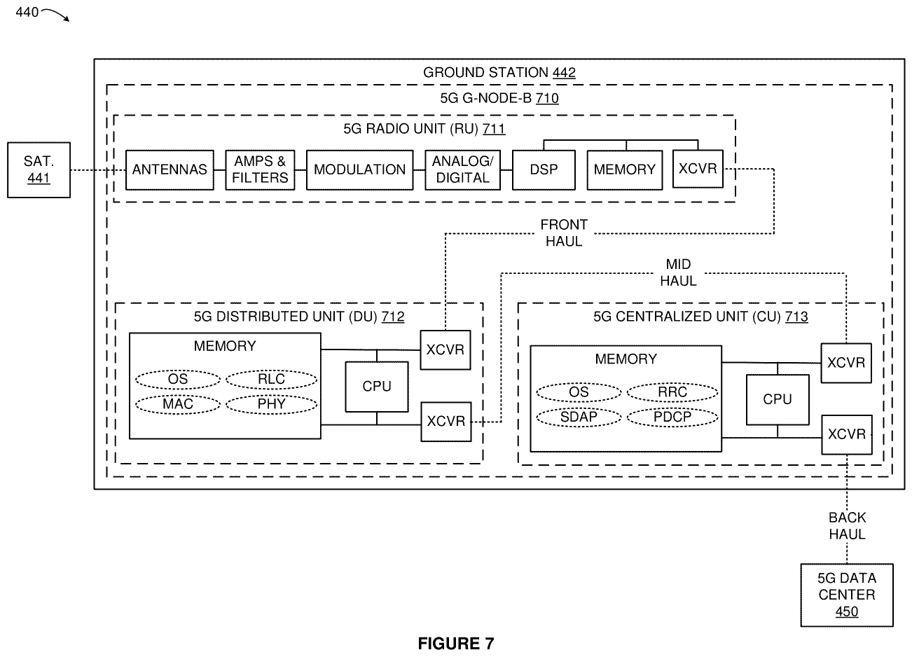

FIG. 7 illustrates ground station 442 in NT AN 440 in 5G communication network 400. Ground station 442 comprises 5G gNodeB 710. 5G gNodeB 710 comprise 5G RU 711, 5G DU 712, and 5G CU 713. RU 711 comprises 5GNR antennas, amplifiers, filters, modulation, analog-to-digital interfaces, DSP, memory, and transceivers (XCVRs) that are coupled over bus circuitry. Satellite 441 is wirelessly coupled to antennas in RU 711 over 5GNR links. Transceivers in RU 711 are coupled to transceivers in DU 712 over fronthaul links like enhanced Common Public Radio Interface (eCPRI). The DSPs in RU 711 execute their operating systems and radio applications to exchange 5GNR signals with satellite 441 and to exchange 5GNR data with DU 712.

For the uplink, the antennas in RU 711 receive wireless signals from satellite 441 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 712 over the transceivers.

For the downlink, the DSPs receive downlink 5GNR symbols from DU 712. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to satellite 441 that transport the downlink 5GNR signaling and data.

DU 712 comprises memory, CPU, and transceivers that are coupled over bus circuitry. The memory in DU 712 stores operating systems and 5GNR network applications like PHY, MAC, and RLC. CU 713 comprises memory, CPU, and transceivers that are coupled over bus circuitry. The memory in CU 713 stores an operating system, data structure 702, and 5GNR network applications like PDCP, SDAP, and RRC. Transceivers in DU 712 are coupled to transceivers in RU 711 over front-haul links. Transceivers in DU 712 are coupled to transceivers in CU 713 over mid-haul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

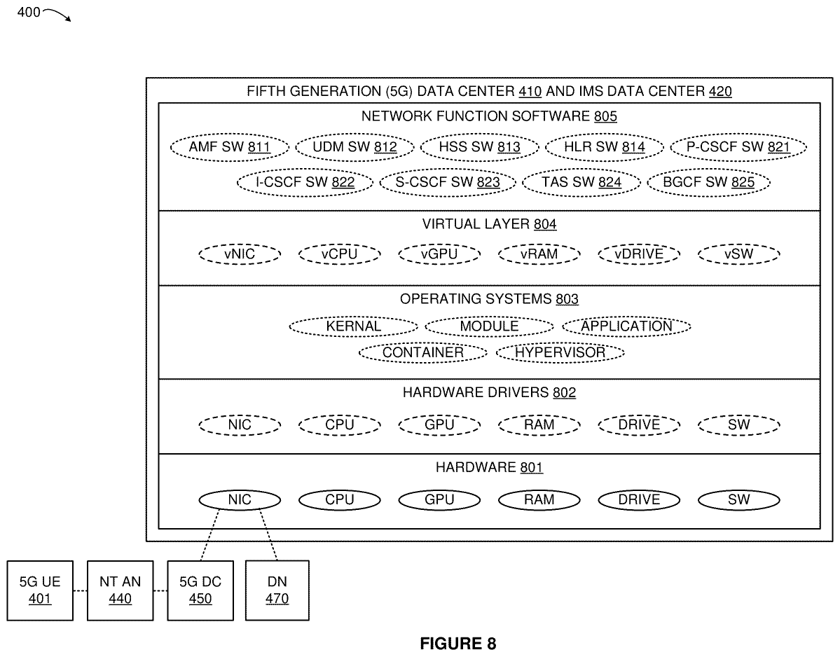

FIG. 8 illustrates 5G data center 410 and IMS data center 420 in 5G communication network 400. 5G data center 410 comprises an example of core network 110 illustrated in FIG. 1, although core network 110 may differ. IMS data center 420 comprises an example of IMS 120 illustrated in FIG. 1, however IMS 120 may differ. 5G data center 450 and IMS data center 460 comprise a similar architecture to 5G data center 410 and IMS data center 420. 5G data center 410 typically comprises a virtualized computing architecture like NFVI, but may comprise another computing architecture like a cloud computing network, a hybrid cloud network, and the like. 5G data center 410 comprises hardware 801, hardware drivers 802, operating systems 803, virtual layer 804, and network function software 805. Hardware 801 comprises Network Interface Cards (NICs), CPU, GPU, RAM, Flash/Disk Drives (DRIVE), and Data Switches (SW). Hardware drivers 802 comprise software that is resident in the NIC, CPU, GPU, RAM, DRIVE, and SW. Operating systems 803 comprise kernels, modules, applications, containers, hypervisors, and the like. Virtual layer 804 comprises vNIC, vCPU, vGPU, vRAM, vDRIVE, and vSW. Network function software 805 comprises AMF Software (SW) 811, UDM SW 812, HSS SW 813, HLR SW 814, P-CSCF SW 821, I-CSCF SW 822, S-CSCF SW 823, TAS SW 824, and BGCF SW 825. Additional network function software for network functions like SMF, UPF, AUSF, NSSF, PCF, UDR, CHF, NRF, SMSF, NEF, AF, EIR, and SCP is typically present but is omitted for clarity. 5G data center 410 and IMS data center 420 may be located at a single site or be distributed across multiple geographic locations. For example, 5G data center 410 may comprise an NFVI at a first site and IMS data center 420 may comprise a NFVI at a second site. The NIC in hardware 801 is coupled to 5G gNodeB 510, data network (DN) 530, and to external systems (not illustrated). Hardware 801 executes hardware drivers 802, operating systems 803, virtual layer 804, and network function software 805 to form AMF 411, UDM 412, HSS 413, HLR 414, P-CSCF 421, I-CSCF 422, S-CSCF 423, TAS 424, and BGCF 425.

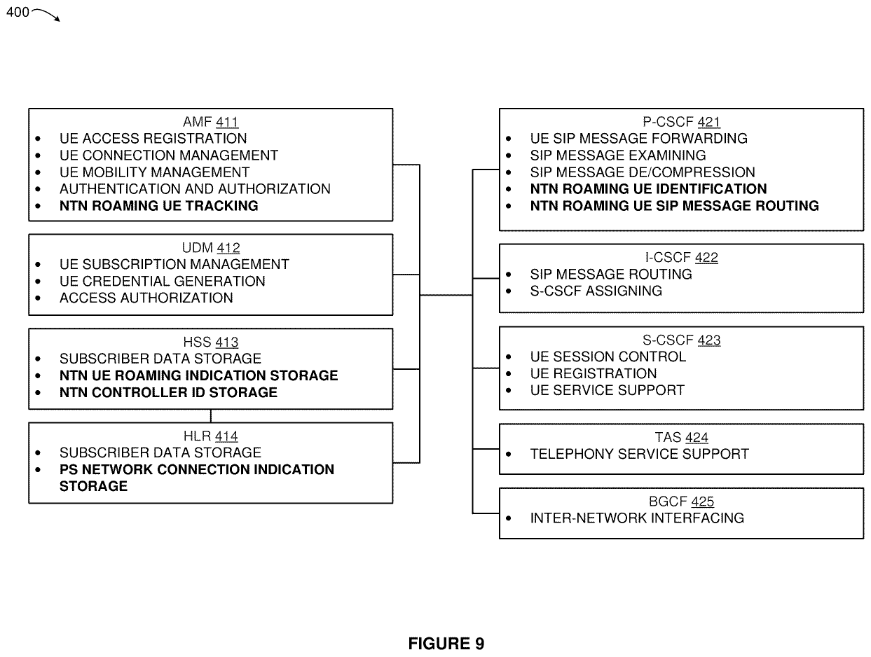

FIG. 9 further illustrates 5G data center 410 and IMS data center 420 in 5G communication network 400. AMF 411 comprises capabilities for UE registration, UE connection management, UE mobility management, authentication, authorization, and Non-Terrestrial Network (NTN) roaming UE tracking. UDM 412 comprises capabilities for UE subscription management, UE credential generation. HSS 413 comprises capabilities for subscriber data storage, NTN UE roaming indication storage, and NTN controller ID storage. HLR 414 comprises capabilities for subscriber data storage and Packet Switching (PS) network connection indication storage. P-CSCF 421 comprises capabilities for UE SIP message forwarding, SIP message examining, SIP message compression/decompression, NTN roaming UE identification, and NTN roaming UE SIP message routing. I-CSCF 422 comprises capabilities for SIP message routing and S-CSCF assigning. S-CSCF 423 comprises capabilities for UE session control, UE registration, and UE service support. TAS 424 comprises capabilities for telephony service support. BGCF 425 comprises capabilities for inter-network interfacing.

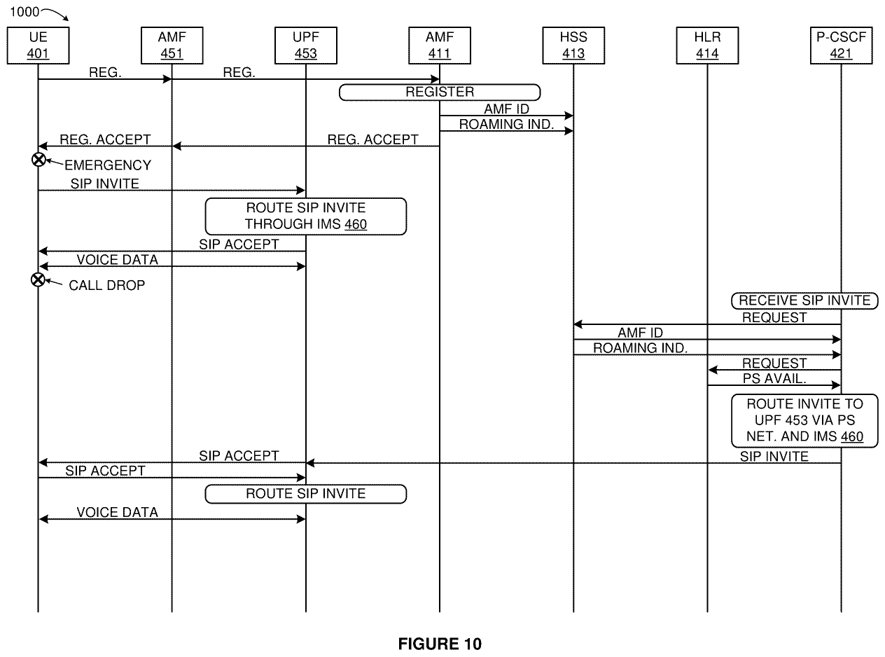

FIG. 10 illustrates process 1000. Process 1000 comprises an exemplary operation of 5G communication network 400 to route an emergency session invite to a UE via non-terrestrial communication network 430 in response to call failure. Process 1000 comprises an example of process 200 illustrated in FIG. 2 and process 300 illustrated in FIG. 3, however processes 200 and 300 may differ. Process 1000 may vary in other examples. In some examples, UE 401 elects to roam on non-terrestrial communication network 430 and attaches to NT AN 440. UE 401 transfers a registration request to AMF 451. The registration request includes the PLMN ID for 5G communication network 400. AMF 451 forwards the registration request to AMF 411 based on the PLMN ID. AMF 411 interacts with UDM 412 to authenticate and authorize UE 401 for roaming service. Responsive to authentication and authorization, AMF 411 interacts with UDM 412 to generate context for UE 401. AMF 411 transfers an AMF ID for AMF 451 and a roaming indication to HSS 413. HSS 413 stores the AMF ID and indication in UE 401's subscriber profile. AMF 411 transfers a registration accept message to AMF 451 and directs AMF 451 to serve UE 401 based on the context. AMF 451 directs SMF 452 to establish the requested PDU sessions for UE 401. SMF 452 controls UPF 453 to establish data links that traverse NT AN 440 to UE 401. SMF 452 notifies AMF 451 that the PDU sessions are ready to begin. AMF 451 transfers the registration accept message to UE 401 over NT AN 440.

After registration, the user of UE 401 experiences an emergency and places a call for 911 using UE 401. In response, UE 401 transfers a SIP invite to P-CSCF 461 via NT AN 440 and UPF 453. P-CSCF 461 interfaces with I-CSCF 462 and S-CSCF 463 to deliver the SIP invite to emergency services. P-CSCF 461 receives a SIP accept message from the emergency services and routes the message to UE 401 over UPF 453 and NT AN 440. S-CSCF 463 organizes an end-to-end link between UE 401 and the emergency services. UE 401 begins the call and exchanges voice data with the emergency services over the end-to-end connection that traverses NT AN 440, UPF 453, and data network 470. S-CSCF 463 and TAS 464 monitor and support the call.

An error occurs during the voice call causing the call to drop. The emergency services detect the call failure and dial the phone number of UE 401 to reestablish the call. P-CSCF 421 receives the SIP invite based on UE 401's association with 5G communication network 400. UE 401 does not have an active IMS registration with IMS data center 420. P-CSCF 421 transfers a request to HSS 413 to locate UE 401. HSS 413 provides the roaming indication and AMF ID for AMF 451 to P-CSCF 421. P-CSCF 421 transfers a request to HLR 414 to determine packet switching network connection availability. HLR 414 indicates that a packet switching network connection between IMS data centers 420 and 460 is available. P-CSCF 421 determines UE 401 is roaming on non-terrestrial communication network 430, identifies AMF 451 in 5G data center 450, and determines an underlying packet switching network connection is available based on the received information. P-CSCF 421 routes the SIP invite to P-CSCF 461 via BGCF 425 and BGCF 465 over the packet switching network. P-CSCF 461 delivers the SIP invite to UE 401 via UPF 453 and NT AN 440. UE 401 accepts the call and transfers a SIP accept message towards the emergency services via UPF 453 and data network 470 to reestablish the voice call. UE 401 restarts the call and exchanges voice data with the emergency services over the end-to-end connection that traverses NT AN 440, UPF 453, and data network 470.

The wireless data network circuitry described above comprises computer hardware and software that form special-purpose network circuitry to route emergency session invites to user devices via non-terrestrial communication networks in response to call failure. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to route emergency session invites to user devices via non-terrestrial communication networks in response to call failure.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
receiving, by a network controller of a home wireless communication network, a registration request for a user device roaming on a visited non-terrestrial communication network from a visited network controller over a roaming interface between the home wireless communication network and the visited non-terrestrial communication network;
registering, by the network controller, the user device for roaming service on the visited non-terrestrial communication network;
storing, by the network controller, an indication in a network data system that indicates that the user device is roaming on the visited non-terrestrial communication network and that identifies the visited network controller;
receiving, by an Internet Protocol Multimedia Subsystem (IMS) of the home wireless communication network, an emergency multimedia session invite for the user device, wherein the user device previously initiated an emergency multimedia session that subsequently failed over the visited non-terrestrial communication network and a visited IMS without registering with the IMS;
accessing, by the IMS, the network data system to determine that the user device is roaming on the visited non-terrestrial communication network and to identify the visited network controller; and
transferring, by the IMS, the emergency multimedia session invite for delivery to the visited network controller wherein the visited network controller delivers the emergency multimedia session invite to the user device over a user plane data link to the user device that traverses a non-terrestrial access node.

2. The method of claim 1 wherein:
storing, by the network controller, the indication in the network data system comprises storing, by the network controller, the indication in the network data system that indicates the user device is roaming on the visited non-terrestrial communication network, identifies the visited network controller, and indicates the visited non-terrestrial communication network comprises a packet switching network connection with the home wireless communication network;
accessing, by the IMS, the network data system comprises accessing, by the IMS, the network data system to determine that the user device is roaming on the visited non-terrestrial communication network, to identify the visited network controller, and to determine the visited non-terrestrial communication network comprises the packet switching network connection with the home wireless communication network; and further comprising:
transferring, by the IMS, the emergency multimedia session invite for delivery to user device via the underlying packet switching network connection between the visited non-terrestrial network and the home wireless communication network.

3. The method of claim 1 wherein the network controller comprises one or more of an Access and Mobility Management Function (AMF) or a Mobility Management Entity (MME).

4. The method of claim 1 wherein the network data system comprises one or more of a Home Subscriber System (HSS), a Home Subscriber Register (HLR), or a Unified Data Management (UDR).

5. The method of claim 1 wherein IMS comprises one or more of a Call Session Control Function (CSCF), a Telephony Application Server (TAS), or a Breakout Gateway Control Function (BGCF).

6. The method of claim 1 wherein the user plane data link to the user device that traverses the non-terrestrial access node comprises a link between one or more of a User Plane Function (UPF) or a Serving Gateway (SGW) and the user device.

7. The method of claim 1 wherein the emergency multimedia session invite comprises a Session Initiation Protocol (SIP) invite.

8. A system comprising:
a network controller, a network data system, and an Internet Protocol Multimedia Subsystem (IMS) of a home wireless communication network;
the network controller configured to:
receive a registration request for a user device roaming on a visited non-terrestrial communication network from a visited network controller over a roaming interface between the home wireless communication network and the visited non-terrestrial communication network;
register the user device for roaming service on the visited non-terrestrial communication network; and
store an indication in the network data system that indicates that the user device is roaming on the visited non-terrestrial communication network and that identifies the visited network controller; and
the IMS configured to:
receive an emergency multimedia session invite for the user device, wherein the user device previously initiated an emergency multimedia session that subsequently failed over the visited non-terrestrial communication network and a visited IMS without registering with the IMS;
access the network data system to determine that the user device is roaming on the visited non-terrestrial communication network and to identify the visited network controller; and
transfer the emergency multimedia session invite for delivery to the visited network controller wherein the visited network controller delivers the emergency multimedia session invite to the user device over a user plane data link to the user device that traverses a non-terrestrial access node.

9. The system of claim 8 wherein:
the network controller is further configured to store the indication in the network data system that indicates the user device is roaming on the visited non-terrestrial communication network, identifies the visited network controller, and indicates the visited non-terrestrial communication network comprises a packet switching network connection with the home wireless communication network; and
the IMS is further configured to:
access the network data system to determine that the user device is roaming on the visited non-terrestrial communication network, to identify the visited network controller, and to determine the visited non-terrestrial communication network comprises the packet switching network connection with the home wireless communication network; and
transfer the emergency multimedia session invite for delivery to user device via the underlying packet switching network connection between the visited non-terrestrial network and the home wireless communication network.

10. The system of claim 8 wherein the network controller comprises one or more of an Access and Mobility Management Function (AMF) or a Mobility Management Entity (MME).

11. The system of claim 8 wherein the network data system comprises one or more of a Home Subscriber System (HSS), a Home Subscriber Register (HLR), or a Unified Data Management (UDR).

12. The system of claim 8 wherein IMS comprises one or more of a Call Session Control Function (CSCF), a Telephony Application Server (TAS), or a Breakout Gateway Control Function (BGCF).

13. The system of claim 8 wherein the user plane data link to the user device that traverses the non-terrestrial access node comprises a link between one or more of a User Plane Function (UPF) or a Serving Gateway (SGW) and the user device.

14. The system of claim 8 wherein the emergency multimedia session invite comprises a Session Initiation Protocol (SIP) invite.

15. One or more non-transitory computer readable storage media having program instructions stored thereon, wherein the program instruction, when executed by a computing system, direct the computing system to perform operations, the operations comprising:
receiving a registration request for a user device roaming on a visited non-terrestrial communication network from a visited network controller;
registering the user device for roaming service on the visited non-terrestrial communication network;
storing an indication in a network data system of a home wireless communication network that indicates that the user device is roaming on the visited non-terrestrial communication network and that identifies the visited network controller;
receiving an emergency multimedia session invite for the user device, wherein the user device previously initiated an emergency multimedia session that subsequently failed over the visited non-terrestrial communication network without registering with an Internet Protocol Multimedia Subsystem (IMS) of the home wireless communication network;
accessing the network data system to determine that the user device is roaming on the visited non-terrestrial communication network and to identify the visited network controller; and
transferring the emergency multimedia session invite for delivery to the visited network controller wherein the visited network controller delivers the emergency multimedia session invite to the user device.

16. The one or more non-transitory computer readable storage media of claim 15 wherein:
storing the indication in the network data system comprises storing the indication in the network data system that indicates the user device is roaming on the visited non-terrestrial communication network, that identifies the visited network controller, and that indicates the visited non-terrestrial communication network comprises a packet switching network connection with the home wireless communication network;
accessing the network data system comprises accessing the network data system to determine that the user device is roaming on the visited non-terrestrial communication network, to identify the visited network controller, and to determine the visited non-terrestrial communication network comprises the packet switching network connection with the home wireless communication network; and wherein the operations further comprise:
transferring the emergency multimedia session invite for delivery to user device via the packet switching network between the visited non-terrestrial network and the home wireless communication network.

17. The one or more non-transitory computer readable storage media of claim 15 wherein the visited network controller comprises one or more of an Access and Mobility Management Function (AMF) or a Mobility Management Entity (MME).

18. The one or more non-transitory computer readable storage media of claim 15 wherein the network data system comprises one or more of a Home Subscriber System (HSS), a Home Subscriber Register (HLR), or a Unified Data Management (UDR).

19. The one or more non-transitory computer readable storage media of claim 15 wherein the visited network controller delivers the emergency multimedia session invite to the user device over a data link between one or more of a User Plane Function (UPF) or a Serving Gateway (SGW) and the user device.

20. The one or more non-transitory computer readable storage media of claim 15 wherein the emergency multimedia session invite comprises a Session Initiation Protocol (SIP) invite.
